(19) United States
(12) Patent Application Publication
(10) Pub. No.: US 2024/0011795 A1
(43) Pub. Date: Jan. 11, 2024

(54) Map Message Sending Method and Apparatus

(71) Applicant: Huawei Technologies Co., Ltd., Shenzhen (CN)

(72) Inventors: Miao Yang, Beijing (CN); Shuo Liu, Beijing (CN); Mingchao Li, Beijing (CN); Yong Wu, Beijing (CN)

(21) Appl. No.: 18/472,013

(22) Filed: Sep. 21, 2023

Related U.S. Application Data
(63) Continuation of application No. PCT/CN2022/079986, filed on Mar. 9, 2022.

(30) Foreign Application Priority Data
Mar. 22, 2021 (CN) 202110303026.3

(51) Int. Cl. G01C 21/00

(52) U.S. Cl. CPC G01C 21/3893

(57) ABSTRACT

A road side apparatus obtains a first map message. The first map message includes map element information describing a map element, and a time attribute of the map element information. The map element includes at least one of a node-level map element, a road-level map element, or a lane-level map element. The map element information includes at least one of node-level map element information, road-level map element information, or lane-level map element information. The road side apparatus sends the first map message. A terminal obtains the map element information and the time attribute from the first map message.

### CROSS-REFERENCE TO RELATED APPLICATIONS

This is a continuation of Int'l Patent App. No. PCT/CN2022/079986, filed on Mar. 9, 2022, which claims priority to Chinese Patent App. No. 202110303026.3, filed on Mar. 22, 2021, both of which are incorporated by reference.

### FIELD

This disclosure relates to the vehicle to everything field, and in particular, to a MAP message sending method and apparatus.

### BACKGROUND

In development of the intelligent vehicle to everything, a road side unit (RSU) broadcasts a map message to provide information like map data of a local area for a vehicle. With great value to a vehicle-to-everything (V2X) application, this manner can improve a capability of an autonomous vehicle to sense an ambient environment, and improve driving safety of the autonomous vehicle.

Generally, the map data indicated in the map message includes a plurality of map elements, and the map elements may include connection relationships between intersections, between road sections, and between lanes, and the like. A traffic environment, a lane attribute, and the like change with time. When the map element like the intersection, the road section, the lane, or the like changes with time, the change cannot be obtained by a vehicle in a timely manner by using an existing map message mechanism to affect driving decision of the vehicle.

### SUMMARY

Embodiments disclose a MAP message sending method and apparatus, to improve timeliness and accuracy of map element information in a map message.

According to a first aspect, an embodiment provides a MAP message sending method, applied to a road side apparatus. The method includes: obtaining a first map message, where the first map message includes map element information describing a map element, and a time attribute of the map element information, the map element includes at least one of a node-level map element, a road-level map element, or a lane-level map element, and the map element information includes at least one of node-level map element information, road-level map element information, or lane-level map element information; and sending the first map message.

The obtaining a first map message may be receiving the first map message or generating the first map message. This is not specifically limited in embodiments.

It can be learned that the first map message includes the node-level map element, the road-level map element, and the lane-level map element. The node-level map element may be an intersection, a ramp entrance, or an endpoint of a road section. The road-level map element may be a road, the road is an infrastructure for various trackless vehicles and pedestrians to pass through, the road may also be referred to as a road section, and each road may include a plurality of lanes. The lane-level map element may be a lane, and the lane is a part that is on a carriageway and that is used for a single column of vehicles to travel.

The map element information indicates an attribute or a status of the map element. The first map message further includes the node-level map element information, the road-level map element information, or the lane-level map element information. The node-level map element information describes an attribute or a status of the node-level map element, for example, including a location of an endpoint of a road section, a prohibited zone at an intersection, information about a traffic light at an intersection, or an upstream/downstream road section connected to the node-level map element. The road-level map element information describes an attribute or a status of the road-level map element, for example, including a road speed limit, a road width, a connection relationship between a road section and an upstream/downstream road section, or a lane set included in the road section. The lane-level map element information describes an attribute or a status of the lane-level map element, for example, including a lane speed limit, a lane sharing attribute, allowed turning behavior, or a connection relationship between a lane and an upstream/downstream lane.

In the foregoing method, the time attribute is set in the first map message, so that timeliness and accuracy of obtaining the map element information by a terminal using the map data are improved. This helps the terminal make a correct decision on route planning, and improves travel efficiency.

In a possible implementation of the first aspect, the time attribute indicates a valid period of the map element information, and the time attribute includes at least one of confidence of the valid period, or a valid start time, a valid end time, or valid duration of the map element information.

The valid start time and the valid end time may be represented by absolute moments (for example, by using a standard time of the National Time Service Center), so that the valid start time and the valid end time are more intuitive and clearer. In another specific implementation, the valid start time and the valid end time may alternatively be represented in a relative time manner (for example, represented based on a time point indicated by a timestamp in the first map message and relative duration, and when the timestamp is 9:00 a.m. Beijing time, relative duration of 2 hours is used to represent a time point at 11:00 a.m. Beijing time), so that a length of the first map message can be effectively reduced, and overheads of resource transmission over an air interface are reduced.

In a possible implementation of the first aspect, the valid duration is duration of the map element information that is based on a timestamp, and the timestamp is a time point indicated by a MinuteOftheYear field in the first map message.

In the foregoing implementation, the valid duration is used to represent a valid time period of the map element information, so that a length of the first map message can be effectively reduced, and overheads of resource transmission over an air interface are reduced.

In a possible implementation of the first aspect, the time attribute is null when the map element information is permanently valid.

In a possible implementation of the first aspect, the time attribute indicates a plurality of time periods, and within each of the plurality of time periods, map element information corresponding to the time period remains unchanged.

In a specific implementation, two groups of map element information respectively corresponding to two adjacent time periods in the plurality of time periods are different. For example, a time period 1 is adjacent to a time period 2, the time period 1 corresponds to a first group of map element information, and the time period 2 corresponds to a second group of map element information. The first group of map element information is different from the second group of map element information. Specifically, there may be at least one of the following cases: Compared with the first group of map element information, in the second group of map element information, a piece of map element information is updated or changed, map element information is added, or the map element information is reduced.

In the foregoing implementation, the time attribute is represented by using the plurality of time periods, so that dynamic changes of the map element information in the plurality of time periods can be intuitively displayed.

In a possible implementation of the first aspect, the time attribute further indicates confidence of each of the plurality of time periods.

In the foregoing implementation, time confidence indicates credibility of a corresponding time period, and the time confidence helps the terminal make a route planning decision based on the credibility of the corresponding time period, and helps improve accuracy of making the route planning decision by the terminal.

In a possible implementation of the first aspect, the method further includes: sending a second map message in response to a change of the map element, where compared with the first map message, at least one of the map element information or the time attribute changes in the second map message, and a moment for sending the second map message is determined based on a moment for the change.

In the foregoing implementation, the second map message is immediately sent in response to the change of the map element, so that a terminal that receives the second map message can master a change of map data in a timely manner and obtain accurate map element information and an accurate time attribute, which has good prewarning effect on a route decision of the terminal.

In a specific implementation, the first map message or the second map message may be sent periodically.

In a possible implementation of the first aspect, the sending the first map message may be specifically: sending the first map message in any one of a broadcast, multicast, or unicast mode.

According to a second aspect, an embodiment provides a MAP message receiving method, applied to a vehicle side apparatus. The method includes: receiving a first map message, where the first map message includes map element information describing a map element, and a time attribute of the map element information, the map element includes at least one of a node-level map element, a road-level map element, or a lane-level map element, and the map element information includes at least one of node-level map element information, road-level map element information, or lane-level map element information; and obtaining the map element information and the time attribute based on the first map message.

In the foregoing method, a terminal obtains the map element information and the time attribute by receiving the first map message that carries the map element information and the time attribute, to master accurate map data in a timely manner. This helps the terminal make a correct decision on route planning, and improves travel efficiency.

In a possible implementation of the second aspect, the time attribute indicates a valid period of the map element information, and the time attribute includes at least one of confidence of the valid period, or a valid start time, a valid end time, or valid duration of the map element information.

In a possible implementation of the second aspect, the valid duration is duration of the map element information that is based on a timestamp, and the timestamp is a time point indicated by a MinuteOftheYear field in the first map message.

In a possible implementation of the second aspect, the time attribute is null when the map element information is permanently valid.

In a possible implementation of the second aspect, the time attribute indicates a plurality of time periods, and within each of the plurality of time periods, map element information corresponding to the time period remains unchanged.

In a possible implementation of the second aspect, two groups of map element information respectively corresponding to two adjacent time periods in the plurality of time periods are different.

In a possible implementation of the second aspect, the time attribute further indicates confidence of each of the plurality of time periods.

In a possible implementation of the second aspect, the method further includes: planning a navigation route based on the map element information and the time attribute.

In the foregoing implementation, the terminal plans the navigation route based on the obtained map element information and the obtained time attribute, so that a road or a lane that is not allowed to pass through at a corresponding moment can be effectively avoided.

According to a third aspect, an embodiment provides a MAP message sending apparatus. The apparatus includes: an obtaining unit configured to obtain a first map message, where the first map message includes map element information describing a map element, and a time attribute of the map element information, the map element includes at least one of a node-level map element, a road-level map element, or a lane-level map element, and the map element information includes at least one of node-level map element information, road-level map element information, or lane-level map element information; and a sending unit configured to send the first map message.

In a possible implementation of the third aspect, the time attribute indicates a valid period of the map element information, and the time attribute includes at least one of confidence of the valid period, or a valid start time, a valid end time, or valid duration of the map element information.

In a possible implementation of the third aspect, the valid duration is duration of the map element information that is based on a timestamp, and the timestamp is a time point indicated by a MinuteOftheYear field in the first map message.

In a possible implementation of the third aspect, the time attribute of the map element information is null when the map element information is permanently valid.

In a possible implementation of the third aspect, the time attribute indicates a plurality of time periods, and within each of the plurality of time periods, map element information corresponding to the time period remains unchanged.

In a possible implementation of the third aspect, two groups of map element information respectively corresponding to two adjacent time periods in the plurality of time periods are different.

In a possible implementation of the third aspect, the time attribute further indicates confidence of each of the plurality of time periods.

In a possible implementation of the third aspect, the sending unit is further configured to send a second map message in response to a change of the map element, where compared with the first map message, at least one of the map element information or the time attribute changes in the second map message, and a moment for sending the second map message is determined based on a moment for the change.

In a possible implementation of the third aspect, the sending unit is further configured to send the first map message in any one of a broadcast, multicast, or unicast mode.

In a possible implementation of the third aspect, the sending unit is further configured to periodically send the first map message or the second map message.

According to a fourth aspect, an embodiment provides a MAP message receiving apparatus. The apparatus includes: a receiving unit configured to receive a first map message, where the first map message includes map element information describing a map element, and a time attribute of the map element information, the map element includes at least one of a node-level map element, a road-level map element, or a lane-level map element, and the map element information includes at least one of node-level map element information, road-level map element information, or lane-level map element information; and a processing unit configured to obtain the map element information and the time attribute based on the first map message.

In a possible implementation of the fourth aspect, the time attribute indicates a valid period of the map element information, and the time attribute includes at least one of confidence of the valid period, or a valid start time, a valid end time, or valid duration of the map element information.

In a possible implementation of the fourth aspect, the valid duration is duration of the map element information that is based on a timestamp, and the timestamp is a time point indicated by a MinuteOftheYear field in the first map message.

In a possible implementation of the fourth aspect, the time attribute of the map element information is null when the map element information is permanently valid.

In a possible implementation of the fourth aspect, the time attribute indicates a plurality of time periods, and within each of the plurality of time periods, map element information corresponding to the time period remains unchanged.

In a possible implementation of the fourth aspect, two groups of map element information respectively corresponding to two adjacent time periods in the plurality of time periods are different.

In a possible implementation of the fourth aspect, the time attribute further indicates confidence of each of the plurality of time periods.

In a possible implementation of the fourth aspect, the processing unit is further configured to plan a navigation route based on the map element information and the time attribute.

According to a fifth aspect, an embodiment provides an apparatus. The apparatus includes a processor and a memory. The processor and the memory are connected or coupled together through a bus. The memory is configured to store program instructions. The processor invokes the program instructions in the memory, to perform the method according to any one of the first aspect or the possible implementations of the first aspect.

According to a sixth aspect, an embodiment provides an apparatus. The apparatus includes a processor and a memory. The processor and the memory are connected or coupled together through a bus. The memory is configured to store program instructions. The processor invokes the program instructions in the memory, to perform the method according to any one of the second aspect or the possible implementations of the second aspect.

According to a seventh aspect, an embodiment provides a computer-readable storage medium. The computer-readable storage medium stores program code to be executed by an apparatus. The program code includes instructions for performing the method according to any one of the first aspect or the possible implementations of the first aspect.

According to an eighth aspect, an embodiment provides a computer-readable storage medium. The computer-readable storage medium stores program code to be executed by an apparatus. The program code includes instructions for performing the method according to any one of the second aspect or the possible implementations of the second aspect.

According to a ninth aspect, an embodiment provides a computer software product. The computer program software product includes program instructions, and when the computer software product is executed by an apparatus, an apparatus performs the method according to any one of the first aspect or the possible embodiments of the first aspect. The computer software product may be a software installation package. When the method provided in any possible design of the first aspect needs to be used, the computer software product may be downloaded and executed on the apparatus, to implement the method according to any one of the first aspect or the possible implementations of the first aspect.

According to a tenth aspect, an embodiment provides a computer software product. The computer program software product includes program instructions, and when the computer software product is executed by an apparatus, an apparatus performs the method according to any one of the second aspect or the possible embodiments of the second aspect. The computer software product may be a software installation package. When the method provided in any possible design of the first aspect needs to be used, the computer software product may be downloaded and executed on the apparatus, to implement the method according to any one of the second aspect or the possible implementations of the second aspect.

### BRIEF DESCRIPTION OF THE DRAWINGS

To describe technical solutions in embodiments more clearly, the following briefly describes the accompanying drawings for describing embodiments. It is clear that the accompanying drawings in the following descriptions show merely some embodiments, and a person of ordinary skill in the art may still derive other drawings from these accompanying drawings without creative efforts.

FIG. 1 is a schematic block diagram of a communication system;

FIG. 2 is a brief schematic diagram of a main structure of a map message;

FIG. 3 is a schematic diagram of a scenario;

FIG. 4 is a brief schematic diagram of a map message according to an embodiment;

FIG. 5 is a brief schematic diagram of another map message according to an embodiment;

FIG. 6 is a brief schematic diagram of still another map message according to an embodiment;

FIG. 7 is a brief schematic diagram of yet another map message according to an embodiment;

FIG. 8 is a brief schematic diagram of still yet another map message according to an embodiment;

FIG. 9 is a flowchart of a map message sending method according to an embodiment;

FIG. 10 is a flowchart of another map message sending method according to an embodiment;

FIG. 11 is a schematic diagram of a manner of sending a map message according to an embodiment;

FIG. 12 is a schematic diagram of another manner of sending a map message according to an embodiment;

FIG. 13 is a schematic diagram of still another manner of sending a map message according to an embodiment;

FIG. 14 is a flowchart of still another map message sending method according to an embodiment;

FIG. 15 is a schematic diagram of a structure of an apparatus according to an embodiment;

FIG. 16 is a schematic diagram of a structure of another apparatus according to an embodiment;

FIG. 17 is a schematic diagram of a function structure of an apparatus according to an embodiment; and

FIG. 18 is a schematic diagram of a function structure of another apparatus according to an embodiment.

### DETAILED DESCRIPTION

The terms used in embodiments are merely for the purpose of illustrating specific embodiments, and are not intended to limit this disclosure. In the specification and claims in embodiments, the terms “first”, “second”, and the like are intended to distinguish between different objects but do not indicate a particular order of the objects.

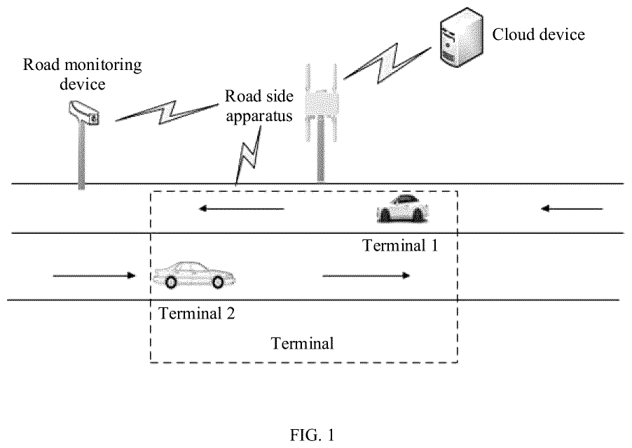

FIG. 1 is a schematic block diagram of a communication system. As shown in FIG. 1, the system includes a road side apparatus, a cloud device, a road side sensing device, and a terminal. There may be one or more terminals (for example, a terminal 1 and a terminal 2). The road side sensing device may be connected to the road side apparatus in a wired or wireless manner. The cloud device and the terminal are separately connected to the road side apparatus in a wireless manner.

The road side apparatus is a key device for implementing smart road and cooperative vehicle infrastructure system. A road side facility may include an apparatus like a road side unit RSU, a multi-access edge computing (MEC), or a sensor. For example, the road side apparatus may be an RSU, a MEC, or a sensor, or may be a system including an RSU and a MEC, or may be a system including an RSU and a sensor, or may be a system including an RSU, a MEC, and a sensor.

The road side sensing device is configured to collect road information and road traffic information. The road side sensing device may be a camera, a laser radar, a millimeter-wave radar, or the like. The cloud device may be a service center computer, a computing device, or the like. The cloud device may be configured to: collect real-time information of a traffic road condition, and process and analyze the collected real-time information of the traffic road condition.

The terminal is a device that supports an LTE-V2X communication function. For example, the terminal may be a vehicle. For example, the vehicle may be generally a transportation means like a car, an automobile, a tourist bus, a bicycle, a tricycle, an electric vehicle, or a truck. Alternatively, the terminal may be an on-board unit (OBU), a user mobile phone, a tablet, an intelligent wearable device (for example, a sports band or a watch), a computer with a wireless receiving function, or the like. The terminal may receive a map message broadcast or multicast by the road side apparatus, and the map message may be used to assist a user in route planning. It should be noted that the terminal may also be referred to as a vehicle side apparatus.

It should be noted that the communication system shown in FIG. 1 may be a 3rd Generation Partnership Project (3GPP) communication system, for example, a Long-Term Evolution (LTE) system, or may be a 5th generation (5G) mobile communication system or a new radio (NR) system, or may be a non-3GPP communication system. This is not specifically limited in this disclosure.

It should be noted that FIG. 1 is merely a diagram of an example architecture, but a quantity of network elements included in the communication system shown in FIG. 1 is not limited. In addition to the functional entities shown in FIG. 1, FIG. 1 may further include another functional entity, although not shown in FIG. 1. In addition, the method provided in this embodiment may be applied to the communication system shown in FIG. 1. Certainly, the method provided in this embodiment may also be applied to another communication system. This is not limited in the embodiments.

It should be noted that, for ease of description, the following describes the solution by using an example in which the road side apparatus is an RSU and the terminal is a vehicle. However, in embodiments, the road side apparatus is not limited to only the RSU, and the terminal is not limited to only the vehicle.

The RSU may send a MAP1 message to the terminal. The MAP1 message indicates map data of a local area. The MAP1 message includes a node, a road section, and a lane of the local area. The node may be an intersection, a ramp entrance, an endpoint of the road section, or the like. Attributes of the node include an ID, a location, a prohibited zone, an upstream road section set connected to the node, and the like. Further, the upstream road section set includes a plurality of road sections. One road section represents a directed line segment between two nodes, namely, a road from one node to another adjacent node. Attributes of the road section include an upstream node ID, a road speed limit, a road width, a connection relationship between the road section and a downstream road section, a lane set included in the road section, and the like. Further, one road section includes at least one lane, and each lane has a unique ID. Attributes of the lane include a lane ID, a lane speed limit, and a lane sharing attribute (briefly referred to as “sharing”), allowed turning behavior (briefly referred to as “turning”), a connection relationship set between the lane and a downstream lane, and the like. The allowed turning behavior includes one or more of going straight, turning right, and turning left.

It should be noted that the map data includes a plurality of map elements, for example, a node-level map element, a road-level map element, and a lane-level map element. Each map element has a plurality of attributes or statuses. The attribute or the status of the map element may also be referred to as map element information, which describes the map element.

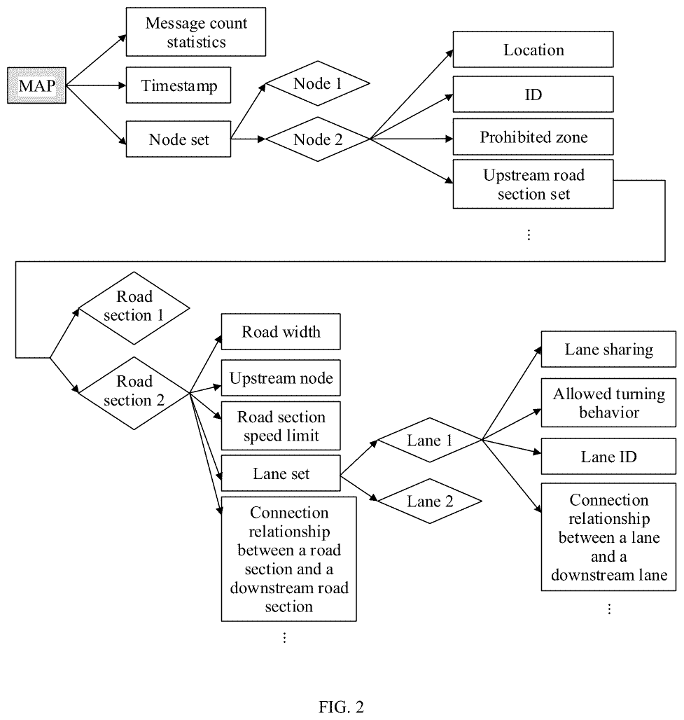

FIG. 2 is a brief schematic diagram of a main structure of a map message. In FIG. 2, it can be learned that a node set (nodes) in the MAP1 message includes a node 1 and a node 2. The node 2 is used as an example to describe related attributes of the node 2, for example, a location (refPos), an ID, a prohibited zone (prohibitedzone), and an upstream road section set (inlinks). The upstream road section set includes a road section 1 and a road section 2. The road section 2 is used as an example to describe related attributes of the road section 2, for example, a road section width (lanewidth), an upstream node ID (upstreamNodeId), a road section speed limit (speedlimts), a lane set (lanes), and a connection relationship (movements) between a road section and a downstream road section. The road section is a road section defined by an upstream node and a current node. The lane set includes a lane 1 and a lane 2. The lane 1 is used as an example to describe related attributes of the lane 1, for example, lane sharing (sharewith), a lane ID (laneID), allowed turning behavior (maneuvers), and a connection relationship (connectsTo) between a lane and a downstream lane. The MAP1 message further includes a timestamp (MinuteOftheYear) and a message statistics count (msgCnt). The timestamp indicates a moment for sending the MAP1 message, and the message statistics count indicates a current total quantity of times for sending the MAP1 message. The message statistics count increases progressively with a quantity of times for sending the MAP1 message.

It can be learned from FIG. 2 that although a vehicle can learn the map data of the local area from the MAP1 message, when a speed limit, a turning relationship, a lane connection relationship, or the like of a lane changes with time, the vehicle cannot learn accurate map information, and therefore cannot better support decision-making on route planning.

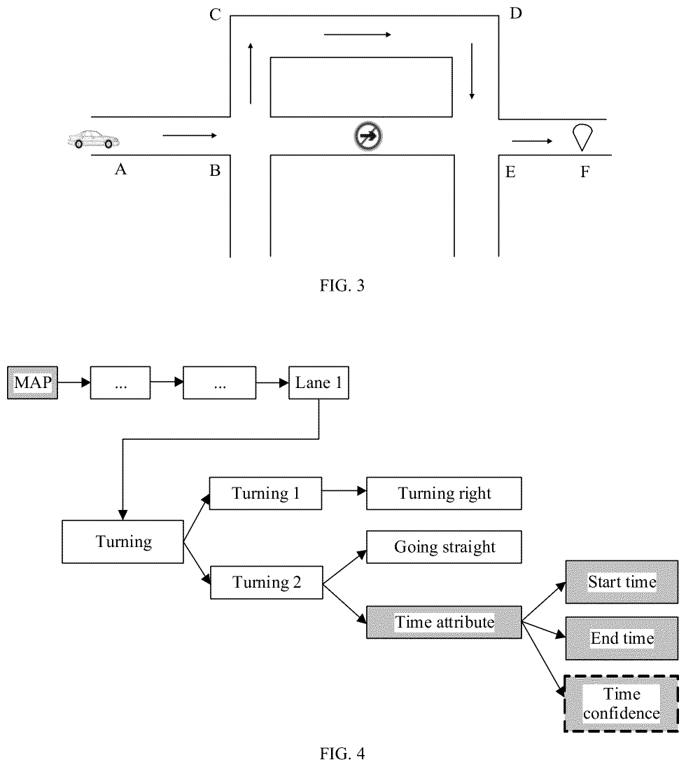

FIG. 3 is a schematic diagram of a scenario. It is assumed that a vehicle is located at a point A at a current moment 9:00 a.m., and a destination of the vehicle is a point F. The vehicle determines, based on a MAP1 message, that an optimal route from the point A to the point F is A-B-E-F, and it takes a shortest time by the route. It is assumed that a road section BE is not allowed to pass through in next 30 minutes due to a vehicle chain rear-end collision event on the road section BE (which is equivalent to that a road section AB supports only turning left in the next 30 minutes). However, because the MAP1 message cannot reflect this change, a navigation route of the vehicle is still A-B-E-F, and the vehicle finds a route planning error only after arriving at a point B. As a result, travel efficiency of a vehicle owner is reduced.

To resolve the foregoing problem, an embodiment provides a MAP2 message. The MAP2 message can indicate a valid period of map element information, to prevent a vehicle from making an incorrect decision on route planning. This improves travel efficiency of a vehicle owner.

A time attribute is added to the MAP2 message based on the MAP1 message. The time attribute indicates the valid period of the map element information, and therefore the MAP2 message can indicate dynamic map data. The time attribute is added based on the MAP1 message in at least the following two manners.

A first manner is first described below.

Specifically, the map data includes a plurality of map elements, and some of the plurality of map elements may dynamically change with time. Therefore, the time attribute of the map element information is set in the MAP2 message, and the time attribute of the map element information indicates the valid period of the map element information. It should be noted that a map element change means that the map element information of the map element changes.

At a node layer, changeable map element information may be a prohibited zone or the like. At a road section layer, changeable map element information may be a road speed limit, a road width, a quantity of lanes in a lane set of the road section, or the like. At a lane layer, changeable map element information may be a lane sharing attribute, allowed turning behavior, a connection relationship between a lane and a downstream lane, a lane speed limit, or the like.

The time attribute of the map element information may be represented by one or more of a start time and an end time. The start time indicates a start moment or an effective moment of the map element information, and the end time indicates a stop moment or an ineffective moment of the map element information.

It should be noted that the start time and the end time are represented in the following two manners, namely, a manner A and a manner B.

Manner A: Both the start time and end time may be represented in an absolute time manner.

Specifically, both the start time and the end time are represented by absolute moments. For example, the map element information is turning, and duration of the turning is described by using the start time to the end time. It is assumed that the lane 1 allows turning right at any moment on month B date C, year A, but supports going straight only at 17:00:00 p.m. to 19:00:00 p.m., month B date C, year A. In this case, the manner A may be represented as a schematic diagram of time description of the MAP2 message shown in FIG. 4. Turning of the lane 1 includes turning 1 “turning right” and turning 2 “going straight”. A time attribute corresponding to “turning right” is null. In other words, it indicates that turning right is allowed on the lane 1 at any moment, and “turning right” in FIG. 4 is permanently valid. A time attribute of “going straight” is represented by a start time and an end time. In this case, the start time may be set to “17:00:00 p.m., month B date C, year A”, and the end time may be set to “19:00:00 p.m., month B date C, year A”. In this case, the time attribute of “going straight” indicates that a valid period of going straight is from 17:00:00 p.m. to 19:00:00 p.m., month B date C, year A. In conclusion, a dynamic change of the turning may be reflected in FIG. 4.

In some possible embodiments, a timestamp may be used to represent common year-month-day information, and the start time may represent only a start moment. Similarly, the end time may represent only a stop moment. Therefore, a length of a message can be reduced, and air interface overheads can be reduced. For example, FIG. 3 is used as an example. If the timestamp in the MAP2 message is set to “month B date C, year A”, a start time of “going straight” may be directly set to “17:00:00 p.m.”, and an end time of “going straight” may be set to “19:00:00 p.m.”.

In some possible embodiments, the time attribute of the map element information further includes time confidence. The time confidence indicates credibility or accuracy of the time attribute of the map element information. Refer to FIG. 4. The “time confidence” may be connected to the “time attribute” of the “going straight”, to represent credibility of the time attribute of “going straight”. For example, if the time attribute of “going straight” is 9:00:00 a.m. to 11:00:00 a.m., and the time confidence is 90%, it indicates that a probability that the turning is “going straight” in the time period from 9:00:00 a.m. to 11:00:00 a.m. is 90%. It may be understood that higher time confidence indicates higher accuracy of the time attribute corresponding to the time confidence.

In a specific implementation, when the time attribute of the map element information is represented only by the end time, it indicates that the start time of the map element information is a moment for sending the MAP2 message by default, and the map element information starts from the moment for sending the MAP2 message and ends at a moment indicated by the end time of the map element information.

In another specific implementation, when the time attribute of the map element information is represented only by the start time, it indicates that the map element information starts from a moment indicated by the start time, and duration of the map element information is not limited, which is equivalent to that the end time of the map element is not limited. It should be noted that the start time may be the moment for sending the MAP2 message. In some possible embodiments, the start time may alternatively be a moment later than the moment for sending the MAP 2 message. This is not specifically limited in embodiments.

Manner B: Both the start time and the end time may be represented in a relative time manner.

Specifically, the start time may be represented by the timestamp and first relative duration, and the end time may be represented by the timestamp and second relative duration. The timestamp may also be referred to as reference time. The first relative duration indicates duration of the start time of the map element information relative to the timestamp, the second relative duration indicates duration of the end time of the map element information relative to the timestamp, and the timestamp indicates the moment for sending the MAP2 message. The three parameters, namely, the timestamp, the first relative duration, and the second relative duration, are included in the MAP2 message.

For example, FIG. 5 is a schematic diagram of a MAP2 message according to an embodiment. In FIG. 5, the time attribute of “going straight” may be determined based on the timestamp, the first relative duration, and the second relative duration. The start time of “going straight” is determined based on the timestamp and the first relative duration, and the end time of “going straight” is determined based on the timestamp and the second relative duration. If it is implemented, based on FIG. 5, that the lane 1 allows turning right at any moment on month B date C, year A, but supports going straight only at 17:00:00 p.m. to 19:00:00 p.m., month B date C, year A, when the timestamp in FIG. 4 is set to “15:00:00 p.m., month B date C, year A”, and the first relative duration of “going straight” is set to “2 hours”, it may be understood that the timestamp and the first relative duration of “going straight” are jointly used to determine that the start time of “going straight” is 17:00:00 p.m.; and when the second relative duration of “going straight” is set to “4 hours”, it may be understood that the timestamp and the second relative duration of “going straight” are jointly used to determine that the end time of “going straight” is 19:00:00 p.m., and no time limitation is imposed on map element information of “turning right”.

In a specific implementation, when the time attribute of the map element information includes only the first relative duration, the start time of the map element may be determined based on the timestamp and the first relative duration, and indicates that the map element information is valid from a moment to which the first relative duration is from the timestamp, but duration of the map element information is not limited. For example, it is assumed that the lane 1 supports turning right at any moment and supports going straight from 11:30:00 a.m. If the MAP2 message is designed based on FIG. 4, the timestamp in FIG. 5 is set to “11:00:00 a.m.”, the time attribute of “going straight” includes only the first relative duration, and the first relative duration is set to “30 min”. Therefore, it may be indicated that the start time of “going straight” is 11:30:00 a.m. based on the timestamp and the first relative duration.

In a specific implementation, when the time attribute of the map element information includes only the second relative duration, the end time of the map element may be determined based on the timestamp and the second relative duration, and a start time of the valid period of the map element information is a moment indicated by the timestamp in the MAP2 message by default. The end time of the map element information is a moment to which the second relative duration is from the timestamp. For example, it is assumed that the lane 1 supports turning right at any moment and supports going straight in a time period from 11:00:00 a.m. to 11:30:00 a.m. If the MAP2 message is designed based on FIG. 5, the timestamp in FIG. 5 is set to “11:00:00 a.m.”, the time attribute of “going straight” includes only the second relative duration, and the second relative duration is set to “30 min”. Therefore, it may be indicated that the end time of “going straight” is 11:30:00 a.m. based on the timestamp and the second relative duration. When the time attribute of “going straight” includes only the second relative duration, the start moment of “going straight” is a moment indicated by the timestamp by default, that is, 11:00:00 a.m. Therefore, the foregoing representation method indirectly indicates that a valid period of “going straight” is 11:00:00 a.m. to 11:30:00 a.m.

It should be noted that, if a time attribute of a piece of map element information is null, it indicates that a valid period of the map element information is not limited. In other words, the map element information is permanently valid.

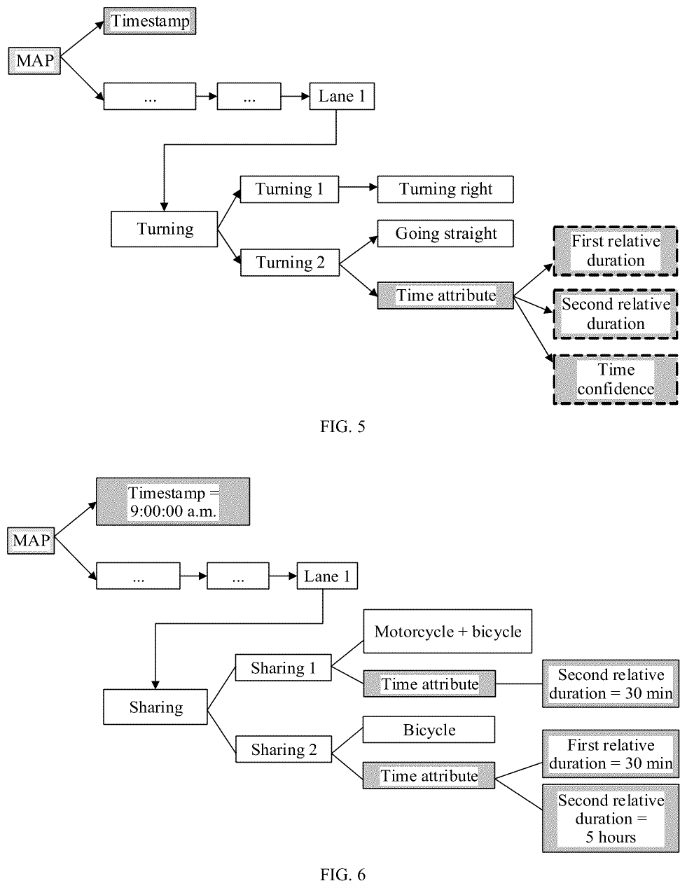

For example, in FIG. 6, the design of the MAP2 message is further described by using the map element information of sharing of the lane 1 as an example. If it is known that a sharing attribute of the lane 1 within 30 min from 9:00:00 a.m. is that only a motorcycle and a bicycle can pass through, and it is predicted that a sharing attribute of the lane 1 from 9:30:00 a.m. to 14:30:00 p.m. is that only a bicycle can pass through, the MAP2 message may be represented in FIG. 6, that is, the timestamp is set to 9:00:00 a.m., and the lane 1 supports two sharing attributes: sharing 1 and sharing 2. The sharing 1 indicates that only a motorcycle and a bicycle can pass through, and the sharing 2 indicates that only a bicycle can pass through. A time attribute of the sharing 1 “motorcycle and bicycle” includes only second relative duration “30 min” used to identify an end time, and a start time is null, that is, the start time starts from a time indicated by the timestamp by default. It may be determined, based on the timestamp, that the end time of the sharing 1 “motorcycle and bicycle” is 9:30:00 a.m., which is equivalent to 9:00:00 a.m. to 9:30:00 a.m., in other words, it indicates that the lane 1 is used only by the bicycle and the motorcycle in a time period from 9:00:00 a.m. to 9:30:00 a.m. A time attribute of the sharing 2 “bicycle” includes first relative duration “30 min” and second relative duration “5 hour”. It may be determined, based on the timestamp and the first relative duration, that a start time of the sharing 2 “bicycle” is 9:30:00 a.m., and that an end time of the sharing 2 “bicycle” is 14:30:00 p.m. In other words, in FIG. 6, the time attribute of the sharing 2 “bicycle” indicates that a valid period of the sharing 2 “bicycle” is 9:30:00 a.m. to 14:30:00 p.m., that is, the lane 1 is used only by the bicycle in a time period from 9:30:00 a.m. to 14:30:00 p.m.

A second manner is described below.

Specifically, in a node-road section-lane structure, any map element includes a plurality of pieces of map element information, and a status change time point of each piece of map element information of the any map element is used as a baseline to represent a status change of the map element over time.

In a specific implementation, the time attribute includes a plurality of status change time points. For example, the plurality of status change time points may be a first time point and a second time point. The first time point is an initial time point of the plurality of status change time points, and the second time point is an adjacent time point of the first time point. The first time point corresponds to map element information 1, and the first time point is also a start time point of a valid period of the map element information 1. The second time point corresponds to map element information 2, and the second time point is also a time point at which the map element information 2 changes. The map element information 2 is map element information that is in the map element information 1 and that changes at the second time point. In other words, the map element information 2 is map element information that is in the map element information 1 and that needs to be updated at the second time point. In this case, other map element information that is in the map element information 1 and that does not need to be updated at the second time point remains unchanged.

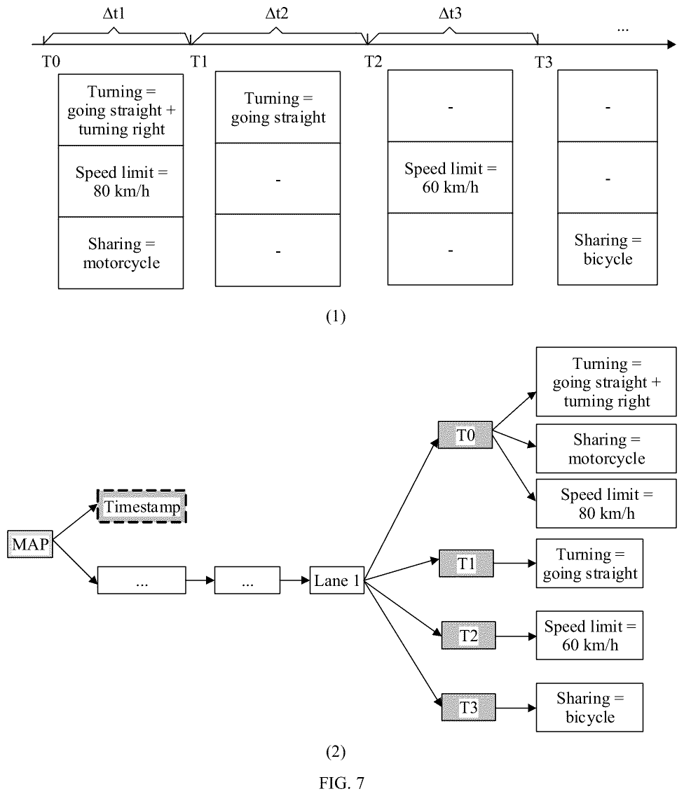

The lane layer is used as an example. It is assumed that a dynamic change of a related attribute of the lane 1 in map data in a time period T0-T3 is shown in (1) of FIG. 7. To be specific, settings corresponding to the lane 1 starting from a moment T0 are as follows: Turning is “going straight and turning right”, a speed limit is “80 km/h”, and sharing is “motorcycle”. At a moment T1, the turning of the lane 1 changes from “going straight+turning right” to “going straight”, but the two pieces of map element information of the speed limit and the sharing, remain unchanged, that is, the speed limit is still “80 km/h” and the sharing is still “motorcycle”. At a moment T2, the speed limit of lane 1 changes from “80 km/h” to “60 km/h”, but the two pieces of map element information of the turning and the sharing remain unchanged, that is, the turning is still “going straight” and the sharing is still “motorcycle”. At a moment T3, the sharing of lane 1 changes from motorcycle to bicycle, but the two pieces of map element information of the turning and the speed limit, remain unchanged, that is, the turning is still “going straight” and the speed limit is still “60 km/h”.

Alternatively, for the related settings of the lane 1 shown in (1) in FIG. 7, it can be learned that there are three pieces of map element information: the sharing, the turning, and the speed limit at the moment T0. The map element information of the turning is set to “going straight+turning right” in a time period T0-T1, but the turning at the moment T1 is updated to “going straight”, and this setting is maintained after the moment T1. The map element information of the speed limit is set to “80 km/h” in a time period T0-T2, but the speed limit is updated to “60 km/h” at the moment T2, and this setting is maintained after the moment T2. The map element information of the speed limit is set to “motorcycle” in the time period T0-T3, but the speed limit is updated to “bicycle” at the moment T3, and this setting is maintained after the moment T3.

Alternatively, for related settings of the lane 1 shown in (1) in FIG. 7, it can be learned that, in the time period T0-T1, the map element information such as “turning=going straight+turning right”, “speed limit=80 km/h”, and “sharing=motorcycle” remains unchanged. In a time period T1-T2, the map element information such as “turning=going straight”, “speed limit=80 km/h”, and “sharing=motorcycle” remains unchanged. In a time period T2-T3, the map element information such as “turning=going straight”, “speed limit=60 km/h”, and “sharing=motorcycle” remains unchanged. At the moment T3 and later, the map element information such as “turning=going straight”, “speed limit=60 km/h”, and “sharing=bicycle” remains unchanged.

If the dynamic change of the lane shown in (1) in FIG. 7 is represented in the second manner, the MAP2 message may be designed in a form shown in (2) in FIG. 7. Details are as follows.

As shown in (2) in FIG. 7, the time attribute of the lane 1 in the MAP2 message has four status change time points: T0, T1, T2, and T3. Any former in T0, T1, T2, and T3 is earlier than the latter. T0 indicates an initial moment of the four status change time points. The map element information of the lane 1 corresponding to the moment T0 includes: the turning “going straight and turning right”, the speed limit “80 km/h”, and the sharing “motorcycle”. Compared with the moment T0, at the moment T1, only the map element information of the turning is changed in the turning, the speed limit, and the sharing. Therefore, “turning=going straight” is set at the moment T1. Compared with the moment T1, at the moment T2, only the map element information of the speed limit is changed in the turning, the speed limit, and the sharing. Therefore, “speed limit=60 km/h” is set at the moment T2. Compared with the moment T2, at the moment T3, only the map element information of the sharing is changed in the turning, the speed limit, and the sharing. Therefore, “sharing=bicycle” is set at the moment T3.

In a specific implementation, the status change time point, for example, T0, T1, T2, and T3 in FIG. 7, may be represented in an absolute time manner, for example, represented by an absolute moment, or may be represented in a relative time manner, for example, represented by a timestamp and relative duration. T0, T1, T2, and T3 in FIG. 7 are used as an example to describe a method for representing a relative moment. In this case, the timestamp in (2) in FIG. 7 represents the moment for sending the MAP2 message, and T0 may be represented as a sum of the timestamp and Δt0, where Δt0 represents a time difference between T0 and the timestamp. T1 may be represented as a sum of T0 and Δt1, where Δt1 represents a time difference between T1 and T0. T2 may be represented as a sum of T1 and Δt2, where Δt2 represents a time difference between T2 and T1. T3 may be represented as a sum of T2 and Δt3, where Δt3 represents a time difference between T3 and T2. In some possible embodiments, any one of T0, T1, T2, and T3 may alternatively be represented by the timestamp and the relative duration based on the timestamp. This is not specifically limited in embodiments.

In some possible embodiments, the MAP2 message may further include time confidence of each status change time point, and the time confidence indicates accuracy of the status change time point. For example, time confidence of T1 is used as an example. In (2) of FIG. 7, “time confidence” may be set for “T1”, and represents the time confidence of T1. Because “turning=going straight” is also connected to “T1”, the time confidence of the moment T1 represents a probability that “turning=going straight” occurs at the moment T1.

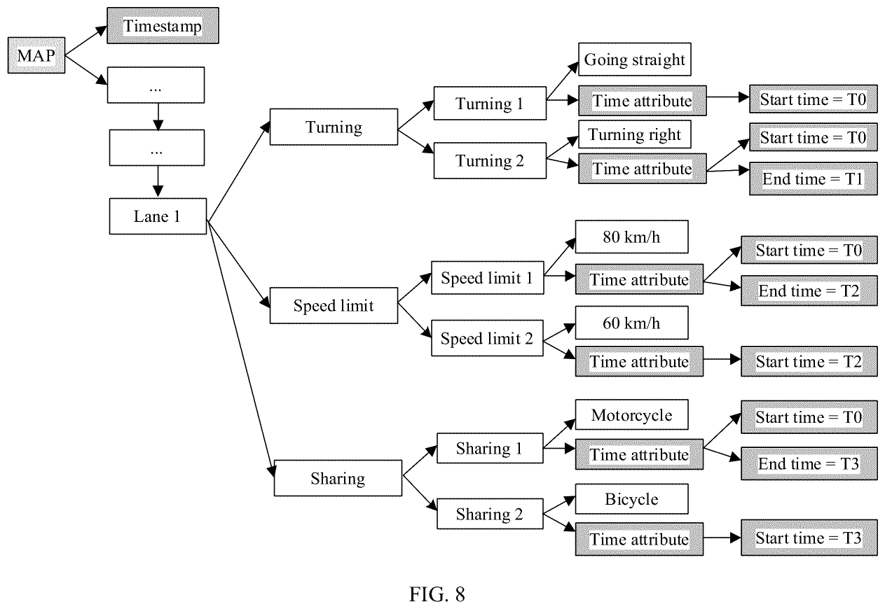

In some possible embodiments, if the MAP2 message is designed in the foregoing first manner, the dynamic change of the lane shown in (1) in FIG. 7 may be represented in a form shown in FIG. 8. In FIG. 8, the map element information of the turning of the lane 1 includes “going straight” and “turning right”. A time attribute corresponding to “turning right” is “T0-T1”, and a time attribute corresponding to “going straight” is “starting from the moment T0”. The map element information of the speed limit of the lane 1 has two settings: “80 km/h” and “60 km/h”. A time attribute corresponding to “80 km/h” is “T0-T2”, and a time attribute corresponding to “60 km/h” is “starting from the moment T2”. The map element information of the sharing of the lane 1 has two settings: “motorcycle” and “bicycle”. A time attribute corresponding to “motorcycle” is “T0-T3”, and a time attribute corresponding to “bicycle” is “starting from the moment T3”.

It should be noted that, in addition to the lane layer in the node-road section-lane three-layer structure of the MAP2 message, the foregoing two manners may be applied to the node layer and the road section layer of the MAP2 message. For example, at the node layer, a time attribute can be set to indicate a valid period of the prohibited zone. For another example, at the road section layer, a time attribute may be separately set to indicate a valid period of one or more map elements in a speed limit of the road section, a connection relationship between the road section and a downstream road section, a quantity of lanes in the lane set, and the like. It should be noted that time attributes of map element information of two map elements, namely, the road section and the lane, in the MAP2 message are associated. For example, a time attribute of map element information of the connection relationship (or referred to as a road section connection relationship) between the road section and the downstream road section in the road section layer is related to a time attribute of map element information of a connection relationship (or referred to as a lane connection relationship) between a lane and a downstream lane in the lane layer, and the time attribute of the map element information of the lane connection relationship in the lane layer is related to a time attribute of map element information of turning of the lane in the lane layer. Therefore, the time attribute of the map element information of the road section connection relationship in the road section layer is also related to the time attribute of the map element information of the turning of the lane in the lane layer. Specifically, the time attribute of the map element information of the lane connection relationship in the lane layer is consistent with the time attribute of the map element information of the turning of the lane in the lane layer, and the time attribute of the map element information of the connection relationship between the road sections in the road section layer is consistent with the time attribute of the map element information of the lane connection relationship in the lane layer.

A specific example is used to indicate that, that the time attribute of the map element information of the lane connection relationship in the lane layer is consistent with the time attribute of the map element information of the turning of the lane in the lane layer means: It is assumed that a time attribute of the turning “going straight” of the lane 1 is 9:00 a.m. to 11:00 a.m., and a time attribute of the turning “turning right” of the lane 1 is 9:00 a.m. to 12:00 a.m. If a lane connection relationship corresponding to “turning right” is “lane 1-lane 2”, and a lane connection relationship corresponding to “going straight” is “lane 1-lane 3”, it may be understood that a time attribute corresponding to the lane connection relationship, namely, “lane 1-lane 2”, is 9:00 a.m. to 12:00 a.m., and a time attribute corresponding to the lane connection relationship, namely, “lane 1-lane 3”, is 9:00 a.m. to 11:00 a.m. Therefore, it can be noted that the turning of the lane is associated with the lane connection relationship, and when the turning of the lane changes, the lane connection relationship also changes.

In some possible embodiments, in addition to using either of the foregoing two manners to set the MAP2 message, both of the foregoing manners may be used to set the MAP2 message. In a specific implementation, time attributes at different layers in the node-road section-lane three-layer structure of the MAP2 message may be represented in different manners. For example, at the node layer and the road section layer, the time attribute may be added to indicate the valid period of the map element information, to represent a status change of the map element information of the node layer and the road section layer (namely, the first manner), and at the lane layer, a status change time point of each map element information may be used as a baseline to represent a status change of the lane (namely, the second manner). In another specific implementation, a time attribute at a same layer in the node-road section-lane three-level structure may be represented in different manners. For example, if a node corresponds to two lanes, at the lane layer, a time attribute may be added to one of the lanes to indicate the valid period of the map element information, to represent a status change of the lane, and on another lane, the status change time point of each map element information is used as a baseline to represent a status change of the another lane. This is not specifically limited in embodiments.

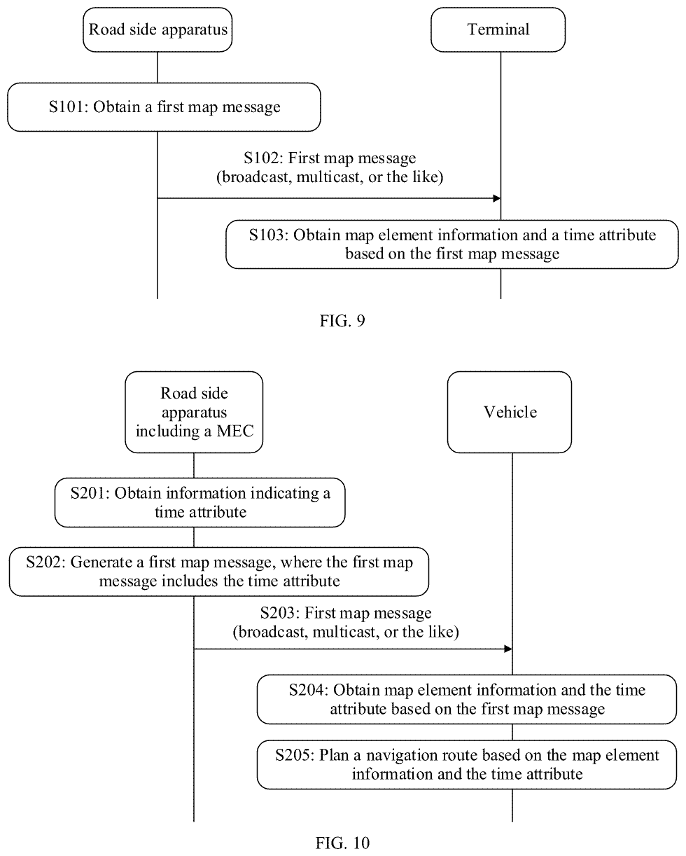

FIG. 9 is a flowchart of a map message sending method according to an embodiment, so that accuracy and timeliness of a map message can be improved. The method includes but is not limited to the following steps.

S101: A road side apparatus obtains a first map message.

In this embodiment, the road side apparatus obtains the first map message. The first map message includes map element information describing a map element, and a time attribute of the map element information, the map element includes at least one of a node-level map element, a road-level map element, or a lane-level map element, and the map element information includes at least one of node-level map element information, road-level map element information, or lane-level map element information. For specific descriptions of the road side apparatus, refer to the related descriptions in the foregoing embodiment.

In a specific implementation, that the road side apparatus obtains the first map message may be: The road side apparatus receives the first map message. For example, the road side apparatus is a device having a communication function, for example, an RSU, a road side sensor, or the like.

In another specific implementation, that the road side apparatus obtains the first map message may be: The road side apparatus generates the first map message. For example, the road side apparatus may be an RSU, an MEC, or the like. In this case, the road side apparatus may first obtain historical and real-time status information of a road from a road side sensing device sensor (for example, a camera, a laser radar, or the like) that can communicate with the road side apparatus, process and analyze the historical and real-time status information to obtain information indicating a time attribute of a map element, and finally generate the first map message. The first map message includes the time attribute corresponding to the map element.

It should be noted that the first map message is the MAP2 message in the foregoing embodiments, and the map element information in the first map message is an attribute of the map element in the MAP2 message in the foregoing embodiments. Specifically, in the first map message, the node-level map element may be an intersection, a ramp entrance, or an endpoint of a road section. The node-level map element information includes at least one of a prohibited zone, a location, an ID, and the like. The road-level map element may be a road (which is also referred to as a road section), the road is an infrastructure for various trackless vehicles and pedestrians to pass through, and each road may include a plurality of lanes. The road-level (which is also referred to as road section level) map element information includes at least one of a road speed limit, a road width, a connection relationship between a road section and a downstream road section, a lane set included in the road section, and the like. The lane-level map element may be a lane, and the lane is a part that is on a carriageway and that is used for a single column of vehicles to travel. The lane-level map element information includes at least one of a lane speed limit, a lane sharing attribute, allowed turning behavior, a connection relationship between a lane and a downstream lane, and the like.

In some possible embodiments, the time attribute indicates a valid period of the map element information, and the time attribute includes at least one of confidence of the valid period, or a valid start time, a valid end time, or valid duration of the map element information. It should be noted that the valid start time is the start time in the foregoing embodiments, and the valid end time is the end time in the foregoing embodiments. For representation manners of the valid start time and the valid duration, refer to the manner A and the manner B in the foregoing embodiment. For brevity of this specification, details are not described herein again. This embodiment corresponds to the first manner in the foregoing embodiment. For details, refer to the related descriptions of the first manner.

In some possible embodiments, the valid duration is duration of the map element information that is based on a timestamp, and the timestamp is a time point indicated by a MinuteOftheYear field in the first map message. It may be understood that, an end time of the valid period of the map element information may be represented based on the timestamp and the valid duration. In another specific implementation, a start time of the valid period of the map element information may alternatively be represented based on the timestamp and the valid duration. This is not specifically limited in embodiments.

In a specific implementation, in the first map message, when a piece of map element information is permanently valid, the time attribute of the map element information is null. Therefore, a length of the first map message can be reduced, and air interface overheads can be reduced.

In some possible embodiments, the time attribute further indicates a plurality of time periods, and within each of the plurality of time periods, map element information corresponding to the time period remains unchanged within the time period. This embodiment corresponds to the second manner in the foregoing embodiment. For details, refer to the related descriptions of the second manner.

For example, refer to (2) in FIG. 7. The time attribute is equivalent to indicating four time periods: T0-T1, T1-T2, T3-T3, and after T3. The two time periods T0-T1 and T1-T2 are used as an example for description. Map element information corresponding to the time period T0-T1 includes “turning=going straight+turning right”, “speed limit=80 km/h”, and “sharing=motorcycle”. The map element information remains unchanged in the time period T0-T1. Map element information corresponding to the time period T1-T2 includes “turning=going straight”, “speed limit=80 km/h”, and “sharing=motorcycle”. The map element information remains unchanged in the time period T1-T2.

It may be understood that two groups of map element information corresponding to two adjacent time periods in the plurality of time periods indicated by the time attribute are different. It is assumed that a time period 1 is adjacent to a time period 2, the time period 1 corresponds to a first group of map element information, and the time period 2 corresponds to a second group of map element information. In this case, the second group of map element information is different from the first group of map element information. Specifically, there may be at least one of the following cases: Compared with the first group of map element information, in the second group of map element information, the map element information is changed, map element information is added, or the map element information is reduced.

For example, in (1) in FIG. 7, the time period T0-T1 is adjacent to the time period T1-T2, the map element information corresponding to T0-T1 includes “turning=going straight+turning right”, “speed limit=80 km/h”, and “sharing=motorcycle”, and the map element information corresponding to T1-T2 includes “turning=going straight”, “speed limit=80 km/h”, and “sharing=motorcycle”. It can be learned that the “turning” corresponding to the time period T1-T2 is changed compared with the “turning” corresponding to the time period T0-T1.

For another example, compared with the first group of map element information, in the second group of map element information, that map element information is added may be as follows: It is assumed that the time period 1 and the time period 2 are adjacent time periods, the first group of map element information corresponding to the time period 1 includes “turning=going straight+turning right” and “sharing=motorcycle”, and the second group of map element information corresponding to the time period 2 includes “turning=going straight+turning right”, “speed limit=80 km/h”, and “sharing=motorcycle”. It can be learned that, compared with the first group of map element information, in the second group of map element information, the map element information “speed limit=80 km/h” is added.

For another example, compared with the first group of map element information, in the second group of map element information, that the map element information is reduced may be as follows: It is assumed that the time period 1 and the time period 2 are adjacent time periods, the first group of map element information corresponding to the time period 1 includes “turning=going straight+turning right”, “speed limit=80 km/h”, and “sharing=motorcycle”, and the second group of map element information corresponding to the time period 2 includes “turning=going straight+turning right”, “speed limit=”, and “sharing=motorcycle”. It can be learned that the “speed limit” in the second group of map element information is set to null, which indicates that the speed limit is not limited in the time period 2. That is, compared with the first group of map element information, in the second group of map element information, the map element information “speed limit=80 km/h” is removed.

In a specific implementation, the time attribute further indicates confidence of each of the plurality of time periods. The credibility of the time period indicates credibility that the map element information corresponding to the time period remains unchanged in the time period.

S102: The road side apparatus sends the first map message.

In this embodiment, the road side apparatus may send the first map message in any one of a broadcast, multicast, or unicast mode, so that a terminal receiving the first map message obtains the map element information and the time attribute.

In a specific implementation, a moment at which the road side apparatus sends the first map message may be an obtaining moment of the first map message, that is, the first map message is immediately sent after being generated. Alternatively, the moment at which the first map message is sent may be a preset moment. This is not specifically limited in embodiments.

In a specific implementation, the road side apparatus may periodically and repeatedly send the first map message, and a moment at which the first map message is sent for the first time may be the obtaining moment of the first map message.

In some possible embodiments, after the first map message is generated, if the map element changes, the road side apparatus sends a second map message in response to the change. Compared with the first map message, at least one of the map element information or the time attribute changes in the second map message. In another specific implementation, the road side apparatus may periodically and repeatedly send the second map message, and a moment at which the second map message is sent for the first time is determined based on a change moment of the map element.

S103: The terminal obtains the map element information and the time attribute from the first map message.

In this embodiment, the terminal receives the first map message from the road side apparatus, and obtains the map element information and the time attribute based on the first map message.

The map element information describes the map element, the time attribute may indicate the valid period of the map element information, and the time attribute includes at least one of the confidence of the valid period, or the valid start time, the valid end time, or the valid duration of the map element information. For the valid start time, the valid end time, the valid duration, and the like, refer to the related descriptions in S101. Details are not described herein again.

In some possible embodiments, the time attribute indicates a plurality of time periods, and within each of the plurality of time periods, map element information corresponding to the time period remains unchanged within the time period. In a specific implementation, the time attribute further indicates confidence of each of the plurality of time periods.

In conclusion, based on the first map message from the road side apparatus, the terminal may learn accurate map data, namely, the map element information and the valid period of the map element information, in a timely manner.

It can be learned that, in embodiments, a map message that carries the time attribute and that is sent by the road side apparatus can effectively improve timeliness and accuracy of the map element information in the map message. In addition, the terminal receives the map message sent by the road side apparatus, to learn accurate the map element information in a timely manner and master a change status of the map element information in a timely manner.

FIG. 10 is a flowchart of a map message sending method according to an embodiment, so that timeliness and accuracy of the map message can be effectively improved, and a route planning decision-making capability of a vehicle end can be improved. The method shown in FIG. 10 is performed by a road side apparatus and a vehicle that include a MEC. The method includes but is not limited to the following steps.

S201: The MEC obtains information indicating a time attribute.

In this embodiment, the MEC obtains the information indicating the time attribute. The time attribute indicates a valid period of map element information. The MEC may be connected to and communicate with a plurality of road side sensing devices. For specific descriptions of the MEC and the map element information, refer to the related descriptions in FIGS. 1 and S101. Details are not described herein again.

In a specific implementation, the MEC obtains, based on status data obtained from the road side sensing device or a cloud device, the information indicating the time attribute. The status data includes a topology relationship between an intersection, a road section, and a lane in a local area, a lane attribute, and a real-time traffic road condition (for example, congestion on a road section, collision of a vehicle in a lane, or the like). The MEC may analyze and process the status data by using an artificial intelligence (AI) algorithm, to predict a valid period of each map element in map data, thereby obtaining the information indicating the time attribute. It should be noted that the AI algorithm may be a long short-term memory (LSTM) network, a random forest algorithm, an autoregressive integrated moving average model (ARIMA) algorithm, or the like. This is not specifically limited in this disclosure.

The status data may be from the road side sensing device (for example, a camera, a laser radar, a millimeter-wave radar, or the like) connected to the MEC, or may be from the cloud device that may communicate with the MEC, or may be from both the road side sensing device and the cloud device. It should be noted that the status data may be at least one of historical data and real-time data. This is not specifically limited in embodiments.

In another specific implementation, that the MEC obtains the information indicating the time attribute means that the MEC receives the information that indicates the time attribute and that is sent by the cloud device. The cloud device (for example, a cloud server) may receive road information (for example, the topology relationship between an intersection, a road section, and a lane, and the lane attribute) and road traffic information (for example, a real-time traffic road condition or a historical traffic road condition) that are sent by the road side sensing device. In other words, it is equivalent to that the status data is stored in a cloud, and the cloud device processes and analyzes the status data by using the foregoing AI algorithm, to predict the valid period (which is also referred to as the time attribute) of each map element in the map data, and sends the information indicating the time attribute to the MEC.

S202: The MEC generates a first map message, where the first map message includes the time attribute.

In this embodiment, after obtaining the information indicating the time attribute, the MEC generates the first map message based on a correspondence between the time attribute and the map element information. The first map message includes the map element information and the time attribute. The map element information describes the map element, and the time attribute indicates the valid period of the map element information. It should be noted that the first map message in S202 is the MAP2 message in the foregoing embodiment. For a specific process of generating the first map message, refer to the related descriptions of the MAP2 message in the foregoing embodiment. For brevity of this specification, details are not described herein again.

S203: The road side apparatus sends the first map message.

In this embodiment, after the first map message is generated, the road side apparatus sends the first map message to the outside, so that the vehicle that receives the first map message replans a navigation route. The first map message may be sent in any one of a broadcast, multicast, or unicast mode. Correspondingly, the vehicle receives the first map message from the road side apparatus, and may perform operations such as planning and decision-making on a route based on the received first map message.

In some possible embodiments, after the MEC generates the first map message, the MEC first sends the first map message to an RSU in the road side apparatus, and then the RSU sends the first map message to at least one vehicle in a range in which the RSU is located.

The MEC may send the first map message in any one of the following manners.

In a specific implementation, after the first map message is generated, the first map message is immediately sent, that is, a moment for sending the first map message is a generation moment of the first map message.

In another specific implementation, the first map message may be periodically and repeatedly sent, and a moment at which the first map message is sent for the first time may be the generation moment of the first map message or a preset moment.

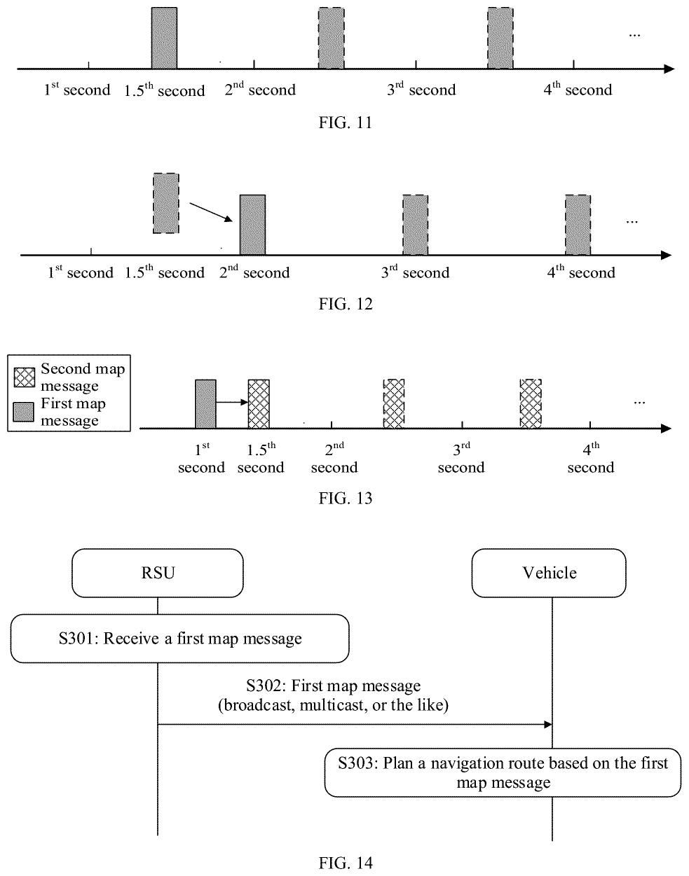

For example, FIG. 11 is a schematic diagram of message sending according to an embodiment. It is assumed that the first map message is generated at a 1.5th second, the first map message may be directly sent at the 1.5th second. For another example, before the first map message changes, the first map message may be separately sent at a 2.5th second, a 3.5th second, and the like subsequently by using the moment (that is, the 1.5th second) at which the first map message is sent for the first time as a start point and using is as a period. It should be noted that a dashed rectangular frame in FIG. 11 represents a subsequent to-be-sent map message, and a solid rectangular frame represents a sent map message.

For example, FIG. 12 is a schematic diagram of message sending according to an embodiment. It is assumed that the first map message is generated at the 1.5th second, the first map message may alternatively be sent at the preset moment, namely, a 2nd second. For another example, the first map message may alternatively be periodically sent, and the moment at which the first map message is sent for the first time is the 2nd second, that is, the first map message is repeatedly sent at a 3rd second, a 4th second, and the like subsequently. It should be noted that a dashed rectangular frame in FIG. 11 represents a subsequent to-be-sent map message, and a solid rectangular frame represents a sent map message.

In some possible embodiments, after sending the first map message, the MEC may further send a second map message in response to a change of the map element. Compared with the first map message, at least one of the map element information or the time attribute changes in the second map message, and a moment for sending the second map message is determined based on a change moment of the map element.

For example, FIG. 13 is a schematic diagram of message sending according to an embodiment. It is assumed that the first map message is sent at a 1st second, and the map element changes at the 1.5th second. In this case, the MEC generates the second map message at the 1.5th second in response to the change of the map element, and directly sends the second map message at the 1.5th second. Map element information in the second map message is different from the map element information in the first map message, and/or a time attribute in the second map message is different from the time attribute in the first map message. In some possible embodiments, in FIG. 13, the second map message may alternatively be periodically and repeatedly sent, and a moment at which the second map message is sent for the first time is the change moment of the map element, that is, the 1.5th second.

It should be noted that the time attribute in the first map message includes a description of a future time period of the map element. Therefore, the moment at which the first map message is sent for the first time should be earlier than the future time period, so that the vehicle can be reminded in advance that the map data is to change, and good prewarning effect is provided.

S204: The vehicle obtains the map element information and the time attribute based on the first map message. For details of this step, refer to the related descriptions of S103 in FIG. 9.

S205: The vehicle plans a navigation route based on the map element information and the time attribute.

In this embodiment, the vehicle may plan the navigation route based on the map element information and the time attribute that are in the first map message, to avoid, in the navigation route, a road or a lane that is not allowed to pass through at a corresponding moment.

For example, FIG. 3 is a schematic diagram of a scenario. It is assumed that the vehicle is located at a point A at a current moment 9:00 a.m., and a destination of the vehicle is a point F. It may be understood that an optimal route of the vehicle from the point A to the point F is A-B-E-F. However, it is assumed that the vehicle receives the first map message at the point A, and the first map message indicates that a road section AB supports only turning left in next 30 min. If it takes 5 minutes for the vehicle to move from the point A to the point B, after receiving the first map message, the vehicle discards the originally planned route A-B-E-F, and the vehicle learns, based on the map message, that a road section BE is impassable in the next 30 min, and therefore replans the navigation route as A-B-C-D-E-F. In this way, the vehicle can master a change status of a traffic environment in advance and adjust a travel route of the vehicle in a timely manner. This helps improve travel efficiency.

In some possible embodiments, the time attribute may further include time confidence. When the time confidence is greater than a preset threshold, for example, when the time confidence is 100%, it indicates that a time attribute corresponding to the time confidence has high credibility, and the first map message may directly affect a decision making on the navigation route of the vehicle. When the time confidence is less than or equal to the preset threshold, for example, when the time confidence is 20%, it indicates that the time attribute corresponding to the time confidence has low credibility. Therefore, when planning the navigation route, the vehicle needs to reference the first map message, and further needs to comprehensively analyze and process, in combination of information about a road condition ahead sent by another vehicle, a road traffic event sent by the cloud device, and the like, the information, to plan the navigation route.

It should be noted that, that the vehicle plans the navigation route based on the received first map message is merely an example of a scenario provided in embodiments. In some possible embodiments, the first map message generated in embodiments may be further used in a field like an advance driver assistant system (ADAS), an automated driving system (ADS), or the like, to assist in guiding an autonomous vehicle to make a correct driving decision as much as possible.

It can be learned that, in embodiments, the time attribute is set in the map message, so that timeliness and accuracy of the map element information in the map message can be effectively improved, and the vehicle that receives the map message can obtain accurate map data in a timely manner. This helps improve a route planning decision-making capability of the vehicle.

FIG. 14 is a flowchart of a map message sending method according to an embodiment. The method shown in FIG. 14 is performed by an RSU and a vehicle. The method includes but is not limited to the following steps.

S301: The RSU receives a first map message.

In this embodiment, the RSU receives the first map message. For descriptions of the first map message, refer to the related descriptions of the first map message in S101 in FIG. 9. Details are not described herein again. The RSU is mainly used in vehicle-to-infrastructure communication, and is usually disposed on a road side.

The first map message received by the RSU may be from a cloud computing device, a MEC, a CU, or another sensor or apparatus integrated with a MEC or a CU. The MEC is used as an example. The MEC generates the first map message based on S202, and sends the first map message to the RSU. Correspondingly, the RSU receives the first map message.

S302: The RSU sends the first map message. For details of this step, refer to the related descriptions of S203 in the embodiment of FIG. 10. In this case, the “MEC” in S203 may be replaced with the “RSU”. For brevity of this specification, details are not described herein again.

S303: The vehicle plans a navigation route based on the first map message.

For details, refer to the related descriptions of S204 and S205 in the embodiment of FIG. 10. For brevity of this specification, details are not described herein again.

It can be learned that, in embodiments, the road side unit sends a map message carrying a time attribute, so that not only timeliness and accuracy of map element information in the map message are improved, but also the vehicle obtains accurate map data in a timely manner. This helps improve a route planning decision-making capability of the vehicle.

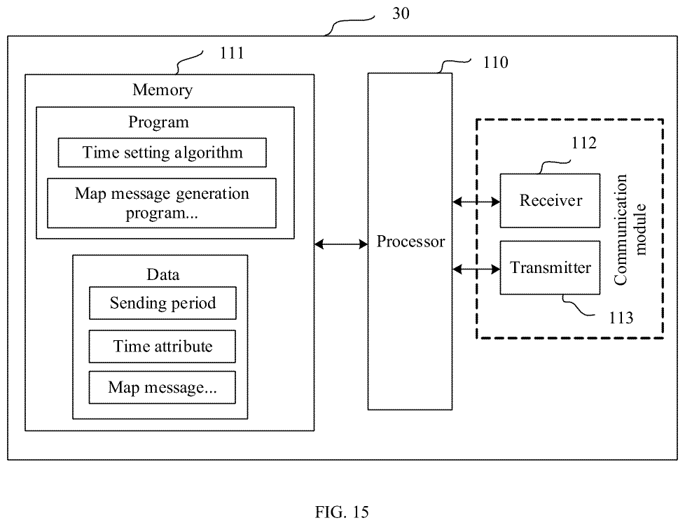

FIG. 15 is a schematic diagram of a structure of an apparatus according to an embodiment. The apparatus 30 includes at least a processor 110, a memory 111, a receiver 112, and a transmitter 113. The receiver 112 and the transmitter 113 may also be replaced with a communication interface or a microwave antenna configured to provide an information input and/or output for the processor 110. Optionally, the memory 111, the receiver 112, the transmitter 113, and the processor 110 are connected or coupled through a bus. The apparatus 30 may be the road side apparatus in the embodiment of FIG. 1, or may be the MEC in FIG. 10 or the RSU in FIG. 14.

In embodiments, the apparatus 30 is configured to implement the method performed by the road side apparatus described in the foregoing embodiment of FIG. 9, or may be configured to implement the method on the MEC side described in the embodiment of FIG. 10 and the method on the RSU side described in the embodiment of FIG. 14.

The receiver 112 may be configured to obtain a first map message. In some possible embodiments, the receiver 112 may be further configured to receive road information, road condition information, and the like that are sent by a road side sensing device (for example, a camera, a laser radar, or the like) or a cloud device. The transmitter 113 is configured to send the first MAP message. In some possible embodiments, the transmitter 113 may be further configured to send a second map message. Compared with the first map message, at least one of map element information or a time attribute changes in the second map message. The receiver 112 and the transmitter 113 may include an antenna and a chip set that are configured to communicate with a device, a sensor or another entity device in a vehicle directly or through an air interface. The transmitter 113 and the transceiver 112 form a communication module. The communication module may be configured to receive and send information based on one or more other types of wireless communication (for example, protocols), and the wireless communication is, for example, Bluetooth, IEEE 802.11 communication protocols, a cellular technology, Worldwide Interoperability for Microwave Access (WiMAX) or LTE, a ZigBee protocol, dedicated short-range communications (DSRC), or radio-frequency identification (RFID) communication. In some possible embodiments, the communication module may alternatively be a wired interface, for example, an Ethernet interface, a local interconnect network (LIN), or the like. This is not specifically limited in embodiments.

In some possible embodiments, the processor 110 may be configured to generate the first map message including the map element information and the time attribute, for example, perform the step shown in S202 in FIG. 10. The processor 110 may include one or more general-purpose processors, for example, a central processing unit (CPU), or a combination of a CPU and a hardware chip. The hardware chip may be an application-specific integrated circuit (ASIC), a programmable logic device (PLD), or a combination thereof. The PLD may be a complex programmable logic device (CPLD), a field-programmable gate array (FPGA), a generic array logic (GAL), or any combination thereof.

The memory 111 may include a volatile memory, such as a random-access memory (RAM). Alternatively, the memory 111 may include a non-volatile memory, such as a read-only memory (ROM), a flash memory, a hard disk drive (HDD), or a solid-state drive (SSD). Alternatively, the memory 111 may include a combination of the foregoing types of memories. The memory 111 may store a program and data. The stored program includes a map message generation program, a time setting algorithm, and the like, and the stored data includes the first map message, a sending period, the time attribute, the map element information, and the like. The memory 111 may exist independently, or may be integrated into the processor 110.

In addition, FIG. 15 is merely an example of the apparatus 30. The apparatus 30 may include more or fewer components than those shown in FIG. 15, or have different component configuration manners. In addition, the various components shown in FIG. 15 may be implemented by hardware, software, or a combination of hardware and software.

FIG. 16 is a schematic diagram of a structure of an apparatus according to an embodiment. The apparatus 40 includes at least a processor 210, a memory 211, and a receiver 212. Optionally, the memory 211, the receiver 212, and the processor 210 are connected or coupled through a bus. The apparatus 30 may be the road side apparatus in the embodiment of FIG. 1. The apparatus 40 may be the terminal in the embodiment of FIG. 1, or may be the vehicle in FIG. 10 and FIG. 14.

In embodiments, the apparatus 40 is configured to implement the method on the terminal side described in the embodiment of FIG. 9, or may be configured to implement the method on the vehicle side described in the embodiment of FIG. 10 or FIG. 14.

The receiver 212 may be configured to receive a first map message. The receiver 212 may be a wireless interface, for example, a cellular network interface or a wireless local area network interface.

The processor 210 is configured to obtain map element information and a time attribute based on the first map message. The processor 210 may include one or more general-purpose processors, for example, a CPU, or a combination of a CPU and a hardware chip. The hardware chip may be an ASIC, a PLD, or a combination thereof. The PLD may be a CPLD, an FPGA, a GAL, or any combination thereof.

The memory 211 may include a volatile memory, such as a RAM. Alternatively, the memory 111 may include a non-volatile memory, such as a ROM, a flash memory, an HDD, or an SSD. Alternatively, the memory 111 may include a combination of the foregoing types of memories. The memory 211 may store a program and data. The stored program includes a map message parsing program and the like, and the stored data includes a navigation map, the first map message, the time attribute, the map element information, and the like. The memory 211 may exist independently, or may be integrated into the processor 110.

In addition, FIG. 16 is merely an example of the apparatus 40. The apparatus 40 may include more or fewer components than those shown in FIG. 16, or have different component configuration manners. In addition, each component shown in FIG. 16 may be implemented by hardware, software, or a combination of hardware and software.

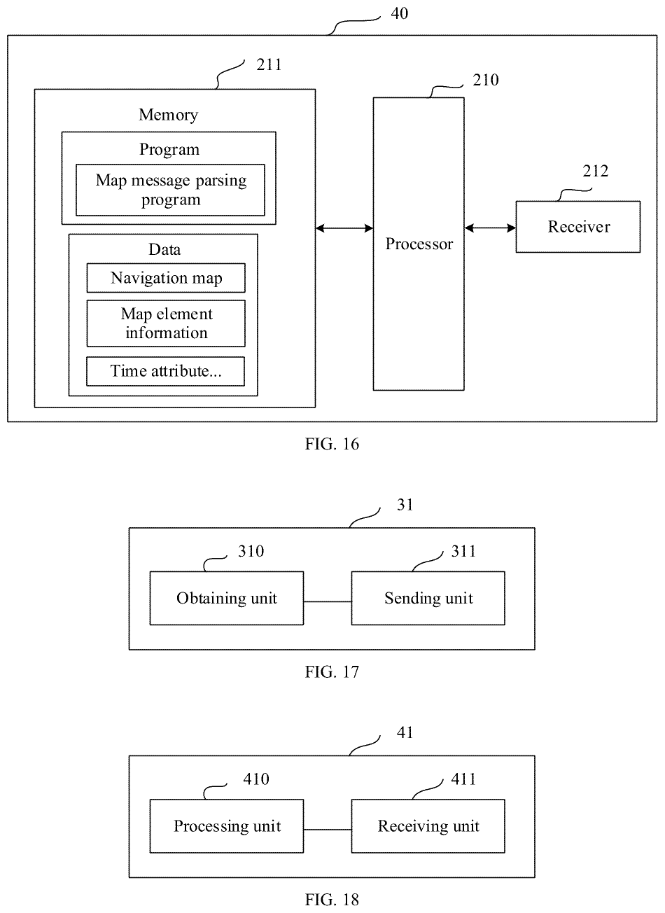

FIG. 17 is a schematic diagram of a function structure of an apparatus according to an embodiment. The apparatus 31 includes an obtaining unit 310 and a sending unit 311. The apparatus 31 may be implemented through hardware, software, or a combination of software and hardware.

The obtaining unit 310 is configured to obtain a first map message. The first map message includes map element information describing a map element, and a time attribute of the map element information, the map element includes at least one of a node-level map element, a road-level map element, or a lane-level map element, and the map element information includes at least one of node-level map element information, road-level map element information, or lane-level map element information. The sending unit 311 is configured to send the first map message.

Function modules of the apparatus 31 may be configured to implement the method described in the embodiment of FIG. 9. In the embodiment of FIG. 9, the obtaining unit 312 may be configured to perform S101, and the sending unit 310 may be configured to perform S102.

The function modules of the apparatus 31 may be further configured to implement the methods described in the embodiments of FIG. 10 and FIG. 14. For brevity of this specification, details are not described herein again.

FIG. 18 is a schematic diagram of a function structure of an apparatus according to an embodiment. The apparatus 41 includes a processing unit 410 and a receiving unit 411. The apparatus 41 may be implemented through hardware, software, or a combination of software and hardware.

The receiving unit 411 is configured to receive a first map message. The first map message includes map element information describing a map element, and a time attribute of the map element information, the map element includes at least one of a node-level map element, a road-level map element, or a lane-level map element, and the map element information includes at least one of node-level map element information, road-level map element information, or lane-level map element information. The processing unit 410 is configured to obtain the map element information and the time attribute based on the first map message. In the embodiment of FIG. 10, the processing unit 410 may be further configured to plan a navigation route based on the map element information and the time attribute.

Function modules of the apparatus 41 may be configured to implement the method described in the embodiment of FIG. 9. In the embodiment of FIG. 9, the receiving unit 411 and the processing unit 410 may be configured to perform S103.

The function modules of the apparatus 41 may be further configured to implement the methods described in the embodiments of FIG. 10 and FIG. 14. For brevity of this specification, details are not described herein again.

In the foregoing embodiments in this specification, the description of each embodiment has respective focuses. For a part that is not described in detail in an embodiment, refer to related descriptions in other embodiments.

It should be noted that a person of ordinary skill in the art may learn that, all or some of the steps in methods of the foregoing embodiments may be implemented by a program instructing related hardware. The program may be stored in a computer-readable storage medium. The storage medium includes a ROM, a RAM, a programmable read-only memory (PROM), an erasable programmable read-only memory (EPROM), a one-time programmable read-only memory (OOTPROM), an electrically-erasable programmable read-only memory (EEPROM), a compact disc read-only memory (CD-ROM), or another optical disk memory, magnetic disk memory, magnetic tape memory, or any other computer-readable medium that can be configured to carry or store data.

The technical solutions essentially, or the part contributing to the conventional technology, or all or some of the technical solutions may be implemented in a form of a software product. The computer software product is stored in a storage medium and includes several instructions for instructing a device (which may be a personal computer, a server, or a network device, a robot, a single-chip microcomputer, a chip, a robot, or the like) to perform all or some of the steps of the methods described in embodiments.

1. An apparatus comprising:
at least one memory configured to store instructions; and
at least one processor coupled to the at least one memory and configured to execute the instructions to cause the apparatus to:
obtain a first map message comprising map element information describing a map element and comprising a time attribute of the map element information, wherein the map element information comprises node-level map element information, road-level map element information, or lane-level map element information, wherein the map element comprises a node-level map element, a road-level map element, or a lane-level map element; and
send the first map message.

2. The apparatus of claim 1, wherein the time attribute indicates a valid period of the map element information, and wherein the time attribute comprises a confidence of the valid period, a valid start time of the map element information, a valid end time of the map element information, or a valid duration of the map element information.

3. The apparatus of claim 2, wherein the valid duration is based on a timestamp indicated by a MinuteOftheYear field in the first map message.

4. The apparatus of claim 2, wherein the time attribute is null when the map element information is permanently valid.

5. The apparatus of claim 1, wherein the time attribute indicates that, within each time period of a plurality of time periods, the map element information corresponding to the time period remains unchanged.

6. The apparatus of claim 5, wherein the time attribute further indicates a confidence of each of the time periods.

7. The apparatus of claim 5, wherein two groups of the map element information respectively corresponding to two adjacent time periods in the time periods are different.

8. The apparatus of claim 1, wherein the at least one processor is further configured to execute the instructions to cause the apparatus to send a second map message at a moment and in response to a change of the map element, wherein the second map message comprises a changed version of the map element information or the time attribute, and wherein the moment is based on when the changed version changed.

9. The apparatus of claim 1, wherein the at least one processor is further configured to execute the instructions to cause the apparatus to further send the first map message in a broadcast mode, a multicast mode, or a unicast mode.

10. The apparatus of claim 8, wherein the at least one processor is further configured to execute the instructions to cause the apparatus to further send the first map message by periodically sending the first map message or send the second map message by periodically sending the second map message.

11. An apparatus comprising:
at least one memory configured to store instructions; and
at least one processor coupled to the at least one memory and configured to execute the instructions to cause the apparatus to:
receive a first map message comprising map element information describing a map element and comprising a time attribute of the map element information, wherein the map element information comprises node-level map element information, road-level map element information, or lane-level map element information, wherein the map element comprises a node-level map element, a road-level map element, or a lane-level map element; and
obtain the map element information and the time attribute from the first map message.

12. The apparatus of claim 11, wherein the time attribute indicates a valid period of the map element information, and wherein the time attribute comprises a confidence of the valid period, a valid start time of the map element information, a valid end time of the map element information, or a valid duration of the map element information.

13. The apparatus of claim 12, wherein the valid duration is based on a timestamp, indicated by a MinuteOftheYear field in the first map message.

14. The apparatus of claim 12, wherein the time attribute is null when the map element information is permanently valid.

15. The apparatus of claim 11, wherein the time attribute indicates that, within each time period of a plurality of time periods, the map element information corresponding to the time period remains unchanged.

16. The apparatus of claim 15, wherein the time attribute further indicates a confidence of each of the time periods.

17. The apparatus of claim 15, wherein two groups of the map element information respectively corresponding to two adjacent time periods in the time periods are different.

18. The apparatus of claim 11, wherein the at least one processor is further configured to execute the instructions to cause the apparatus to plan a navigation route based on the map element information and the time attribute.

19. A computer program product comprising instructions that are stored on a computer-readable medium and that, when executed by a processor, cause an apparatus to:
obtain a first map message comprising map element information describing a map element and comprising a time attribute of the map element information, wherein the map element information comprises node-level map element information, road-level map element information, or lane-level map element information, wherein the map element comprises a node-level map element, a road-level map element, or a lane-level map element; and
send the first map message.

20. The computer program product of claim 19, wherein the time attribute indicates a valid period of the map element information, and wherein the time attribute comprises a confidence of the valid period, a valid start time of the map element information, a valid end time of the map element information, or a valid duration of the map element information.
